(19) United States
(12) Patent Application Publication
(10) Pub. No.: US 2008/0257985 A1
(43) Pub. Date: Oct. 23, 2008

(54) Maximally Decontaminating Mist Spraying Device

(76) Inventors: Lionel Nicolai, Vitrolles (FR); Alain Nicolai, Allauch (FR); Robert Castro, Marseille (FR); Marc Lassus, Marseille (FR)

Correspondence Address: JAMES C. LYDON, 100 DAINGERFIELD ROAD, SUITE 100, ALEXANDRIA, VA, 22314, US

(21) Appl. No.: 11/793,982

(22) PCT Filed: Sep. 2, 2005
(86) PCT No.: PCT/FR2005/002187

§ 371 Date: Aug. 15, 2007

(30) Foreign Application Priority Data
Sep. 28, 2004 (FR) 0410233

(51) Int. Cl. B05B 9/04

(52) U.S. Cl. 239/373

(57) ABSTRACT

The mist spraying device comprises: a mist spraying manifold (14) having a number of mist spraying nozzles; a source of liquid (10) that furnishes the liquid to be supplied to said mist spraying manifold, and; a pump (12) designed for furnishing pressurized liquid from said source to the mist spraying manifold. The device also comprises a particulate filter (16) that retains particles of a size larger than approximately 1? or comprises a charged particulate filter that retains colloidal particles and substances of a size larger than approximately 0.5? (16) while receiving the liquid coming from said source. The inventive device additionally comprises an ultrafiltration filter (18) that receives the liquid coming from the particulate filter for retaining microorganisms of a size larger than 0.2?, and comprises an ultraviolet radiation manifold (20), which receives the liquid coming from the ultrafiltration filter and which is designed for destroying the remaining microorganisms of a size smaller than 0.2?.

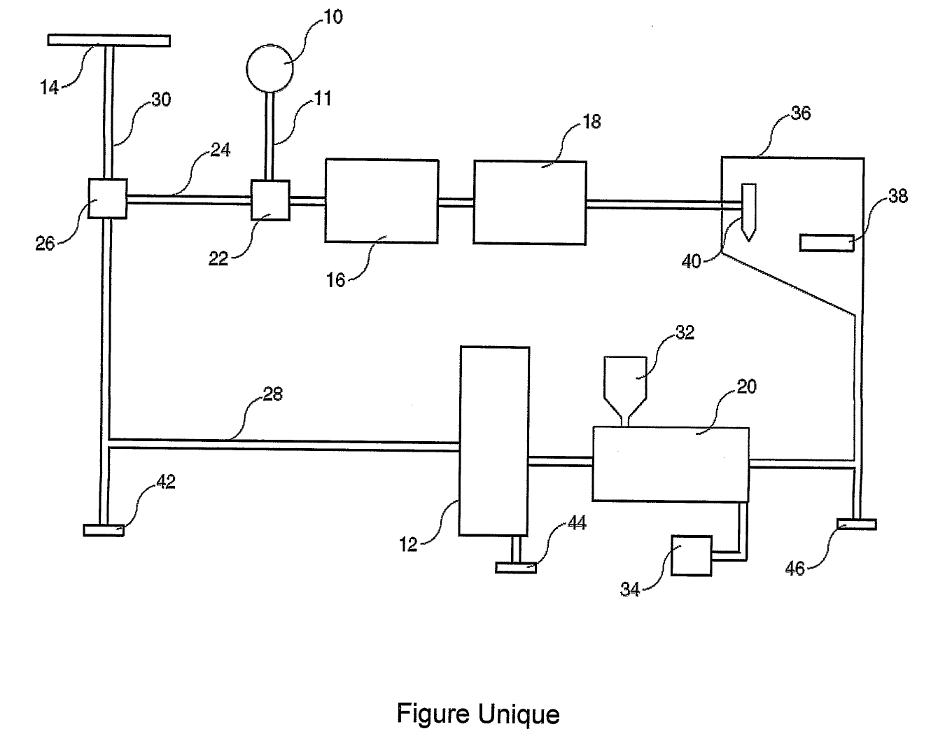

### TECHNICAL FIELD

The present invention relates to water misting devices intended mainly for any institution requiring perfect hygiene from the bacteriological standpoint such as hospital institutions or retirement homes, and relates in particular to a misting device with maximum decontamination.

### STATE OF THE ART

Misting of a liquid, and in particular misting using water, is a cooling technique that is used increasingly in public places in order to combat heat exhaustion particularly during the hottest days of summer. It consists of projecting micro-droplets of water whose size varies from 3 to 20 μm by means of misting nozzles and a pump under a high pressure between 45 and 110 bar.

It is a relatively economical process that is flexible to use, effective and well accepted by users. Unfortunately, few precautions are taken in the existing systems to make sure that the sprayed water does not contain pathogenic microorganisms. Yet the technique of misting, because of its intrinsic characteristics, has the ability to promote proliferation of microorganisms.

This is particularly true for the risks of contamination by legionella bacteria. Now cases of legionella infection are constantly increasing in number, and the majority of these more particularly concern people in a weakened state, such as elderly people with chronic diseases, but also more recently, the youngest people. This contamination is mainly due to one category of legionella bacteria, Legionella pneumophila.

The process of contamination relates to other bacteria and viruses leading to diseases such as SARS or avian influenza. These diseases can be transmitted by any aerolization processes such as misting that generate droplets of which inhalation by the respiratory passages can generate extremely serious, often fatal, pulmonary disorders.

### DISCLOSURE OF THE INVENTION

The aim of the invention is therefore to provide a misting device in which the droplets of liquid supplied by the misting nozzles do not contain any pathogenic microorganisms.

The invention therefore relates to a misting device having a misting manifold containing a number of misting nozzles, a source of liquid that supplies the liquid intended for feeding the misting manifold, and a pump suitable for supplying the liquid coming from the source to the misting manifold under pressure. The misting device moreover has particle filter (16) that retains particles larger than approximately 1 μm, or a charged particle filter that retains particles and colloidal substances larger than approximately 0.5 μm, which receives the liquid coming from the source, and an ultrafiltration filter that receives the liquid coming from the particle filter in order to retain microorganisms larger than 0.2 μm, and an ultraviolet radiation bank that receives the liquid coming from the ultrafiltration filter and that is suitable for destroying the residual microorganisms smaller than 0.2 μm.

### DETAILED DESCRIPTION OF THE INVENTION

The aims, objects and characteristics of the invention will appear more clearly upon reading the following description given in reference to the single FIGURE representing the misting device according to the invention.

Although the device according to the invention represented in the FIGURE can use any liquid, the preferred embodiment described below uses water.

The device illustrated in the FIGURE, like any misting device of this type, has source of water 10, which is generally the water distribution network, pump 12 suitable for supplying water coming out under high pressure between 45 and 110 bar, and misting manifold 14 containing misting nozzles (not shown). Although the invention does not relate to this, it is recalled that misting consists of introducing fine droplets of water into the air, which evaporate very quickly. This causes changes in the physical characteristics of the ambient air that are expressed by an increase in relative humidity and adiabatic cooling (that is to say without exchange of heat with the exterior) by evaporation of the water leading to a lowering of the temperature of the atmosphere. The nozzles consist of a pressurization chamber in which a stainless steel cylinder with fins is situated. The water projected against the cylinder functions as a lubricant, causing it to turn, and the water is broken up into microscopic particles smaller than 10 μm, which are carried outside by the high pressure. A stream of air is created inasmuch as the degree of relative humidity of the air of the whole room tends to become uniform. A natural ventilation of the room is thus obtained. It should be noted that it is also possible to install a fan if one wishes to obtain faster ventilation.

As already mentioned, the misting device according to the invention essentially has particle filter 16 that receives the water coming from source 10, ultrafiltration filter 18 and ultraviolet UV radiation bank 20 in that order.

It should be noted that water intake pipe 11 coming from source 10 ends at first three-way solenoid valve 22. In normal operation, the solenoid valve is in its first position running the water from source 10 toward particle filter 16. In its second position, the water coming from source 10 is shunted through pipe 24 toward second three-way solenoid valve 26 inserted between outlet pipe 28 of the pump and pipe 30 used to feed misting manifold 14. In normal operation, solenoid valve 26 is in its first position, that is, allowing pipe 28 to be connected to pipe 30 for feeding manifold 14. The two solenoid valves are put in their second position in order to bring about complete decontamination of the device as will be seen subsequently.

Particle filter 16 can be a particle filter that retains particles larger than approximately 1 μm, or a charged particle filter that retains particles and colloidal substances larger than approximately 0.5 μm, which receives the liquid coming from the source, which is sufficient for eliminating any turbidity from the water.

Ultrafiltration filter 18 placed after particle filter 16 retains a large portion of the microorganisms, that is, all those larger than 0.2 μm, and it particularly retains bacteria present in the water.

But the ultrafiltration filter is not enough. It is therefore necessary to join with it downstream UVC (Ultra Violet Type C) bank chamber 20 for destroying all microorganisms smaller than 0.2 μm and mainly viruses that are too small to be retained by the ultrafiltration filter.

It should be noted that the presence of the particle filter and of the ultrafiltration filter upstream from the UVC bank is absolutely necessary in order to obtain maximum decontamination, which is the aim of the invention. In effect, the UV bank can operate correctly only if the water is not turbid. Hence the need to place the particle filter upstream, which eliminates the turbidity from the water. But the ultrafiltration filter is just as necessary, since it enables one to block large microorganisms that, without this, could create a screen for microorganisms of infinitesimal size such as viruses. Consequently, the decontamination would not be complete without the presence of these two filters upstream.

The UVC bank is composed of one or more low-pressure mercury vapor lamps emitting a germicidal wavelength of 253.7 to 258 nanometers. These lamps are placed in sheaths made of quartz. The water circulates around the quartz sheaths in treatment chamber 20. These sheaths are used as separation between the lamp or lamps and the liquid as electrical and thermal insulation and enable operation at an optimal temperature.

UV meter 32 continually indicates, as a percentage with respect to the intensity emitted from the lamp at the beginning of its life, the intensity received at the most unfavorable part of the chamber. It constitutes an indicator of effectiveness that takes into account all parameters influencing performance, such as aging of the lamps, fouling of the quartz sheaths covering the lamps and deterioration of the quality of the water. The UV meter makes it possible to drive an alarm device (not shown) that is triggered when the intensity emitted by the lamps is insufficient to ensure complete decontamination of the water.

Automatic cleaning device 34 can be connected to UVC bank chamber 20. This devices acts by scraping in order to eliminate deposits possibly formed on the quartz sheaths and thus masking the radiation. This device therefore prevents the need to remove the lamps and empty the chamber. It can be triggered according to two modes of operation: either by lowering of the intensity of the UVC radiation measured by UV meter 32, or by programming of a regular cycle that depends on the duration of operation of the UVC lamps.

An important characteristic of the device according to the invention is the presence of tank 36 with a capacity greater than 1 liter, situated downstream from ultrafiltration filter 18. It is thus placed so that the maximum quantity of microorganisms is eliminated from the water that it contains by the ultrafiltration filter positioned upstream, the purpose being to avoid the growth of germs in the tank that could lead to contamination.

This tank makes it possible, if necessary, to completely decontaminate the misting device by means of the thermal shock technique. In effect, raising the temperature of the liquid to 70° C. guarantees the elimination of any microorganism. As soon as the misting device is no longer operating, for example, at the end of the day, or if it has not been used for a certain time, the thermal shock process is initiated. For this purpose, tank 36 has heating resistor element 38 that raises the temperature in the tank to 70° C. The two solenoid valves 22 and 26 are then put in their second position, and at the same time, the pump is put in operation for a period of approximately 10 min in order to provide water coming out at a pressure of 5 bar. For this duration, the water circulates in a closed circuit inside the misting device since solenoid valve 26, in the second position, sends the water received from the pump toward solenoid valve 22, which, also in the second position, sends the water toward particle filter 16. It should be noted that the seals used in the misting device are suitable for subjection to a temperature of 70° C.

For the purpose of obtaining the best possible decontamination, the tank has float device 40 making it possible to always maintain the maximum level of water of the tank below the water intake into the latter.

Before being put back in operation, the misting device is emptied so as to eliminate even the least risk of contamination. For this purpose, there are three drain outlets situated in the low part: drain outlet 42 for the misting manifold, drain outlet 44 for the pump and drain outlet 46 for the tank.

It should be noted that all the pipes connecting the elements of the misting device such as pipes 11, 24, 28 or 30 are preferably made of copper, which is a bactericidal metal, or made of copper alloy.

As already mentioned, the misting device just described is particularly suitable for hospital institutions and retirement homes, mainly in the rooms of high-risk, weak, bedridden or dependent patients who are unable to access a cooled common room, but also in the common room (substituting for air conditioning that generates Legionella pneumophila nosocomial infections) allowing that place to be cooled by lowering the ambient temperature by several degrees, generating thermal comfort, in common rooms integrating the installation for misting and ventilation affixed to the ceiling and outside for all games or recreation events for the residents, generating comfort and a pleasant cooling sensation for the participants.

The misting device according to the invention can also be used in public places such as highway rest areas, stations, airport lobbies, or in private places such as patios, restaurant terraces, stores, etc. It can also be used in trade sites such as greenhouses, fish stalls, vegetable stalls or in wet air-cooling towers.

1-10. (canceled)

11. A misting device having misting manifold containing a number of misting nozzles, source of liquid supplying the liquid intended for feeding said misting manifold, pump suitable for supplying the liquid coming from said source to said misting manifold under high pressure, generally between 45 and 110 bar, said device also having particle filter that retains particles larger than approximately 1 μm, or a charged particle filter that retains particles and colloidal substances larger than approximately 0.5 μm, which receives the liquid coming from said source, ultrafiltration filter that receives the liquid coming from said particle filter in order to retain microorganisms larger than 0.2 μm, and chamber with an ultraviolet bank containing one or more UVC lamps placed in quartz sheaths, which receives the liquid coming from said ultrafiltration filter and which is suitable for destroying microorganisms smaller than 0.2 μm;
said device further comprising a UV meter associated with said UV bank chamber, said UV meter continually indicating the amount received at the most unfavorable point of the chamber in percentage with respect to the intensity emitted at the beginning of the life of the lamp or lamps, so as to drive an alarm device that is triggered when the intensity emitted by the lamps is insufficient to ensure complete decontamination of the water.

12. A device according to claim 11, wherein automatic cleaning device is associated with said UV bank chamber, said automatic cleaning device acting by scraping in order to eliminate deposits possibly formed on the quartz sheaths surrounding the lamps.

13. A device according to claim 11, which moreover has first three-way solenoid valve placed between said source and said particle filter and second three-way solenoid valve placed between said pump and said misting manifold, with it possible for said solenoid valves to be put in two positions, a first position allowing normal operation of said misting device and a second position allowing the circulation of the liquid supplied under pressure by the pump in a closed circuit inside said device so as to bring about the decontamination of said device by thermal shock.

14. A device according to claim 13, which moreover has tank in which there is heating resistor element intended for heating the water of the tank to a temperature of 70° C. for a duration of 10 min so as to bring about decontamination of the misting device by thermal shock when said solenoid valves have been put in their second position and said pump has been put in operation in order to circulate the water under a pressure of 5 bar.

15. A device according to claim 14, wherein said tank has float device making it possible to always maintain the maximum level of water in said tank below the water intake into the latter (network disconnection).

16. A device according to claim 14, which moreover has three drain outlets situated in the low part; drain outlet for said misting manifold, drain outlet for said pump and drain outlet for said tank.

17. A device according to claim 11, wherein all the pipes connecting the elements of the misting device are made of copper.

18. A device according to claims 11, wherein said liquid source is a water source.

19. Use of the device according to claim 8 in hospital institutions and retirement homes.

20. Use of the device according to claim 8 in public places, work places or wet air-cooling towers.
